(19) United States
(12) Patent Application Publication
(10) Pub. No.: US 2018/0216681 A1
(43) Pub. Date: Aug. 2, 2018

(54) BRAKE CALIPER

(71) Applicant: JAGUAR LAND ROVER LIMITED, Whitley, Conventry, Warwickshire (GB)

(72) Inventor: Ric HAMPSON, Coventry, West Midlands (GB)

(21) Appl. No.: 15/748,881

(22) PCT Filed: Jul. 21, 2016
(86) PCT No.: PCT/EP2016/067359

§ 371 Date: Jan. 30, 2018

(30) Foreign Application Priority Data
Jul. 30, 2015 (GB) 1513406.7

(51) Int. Cl. F16D 55/228; F16D 65/18; F16D 65/00

(52) U.S. Cl. CPC F16D 55/228; B60T 7/042; F16D 65/0068; F16D 65/183

(57) ABSTRACT

A brake caliper body includes: an opening arranged to receive a portion of a brake disc, the position of the brake disc within the opening, in use, defining a brake disc envelope; at least one pair of coaxial piston bores disposed one to each side of the opening, each piston bore having a closed end defining an end face; and at least one mounting hole. A center of each piston bore end face coincides with an ellipse defined around the brake disc envelope, the ellipse having foci lying within the brake disc envelope and the ellipse being sized to coincide with lengthwise extremities of the disc envelope. The ellipse intersects or is tangential to the or each mounting hole.

### TECHNICAL FIELD

The present disclosure relates to a brake caliper. Particularly, but not exclusively, the present disclosure relates to a brake caliper for a vehicle brake-by-wire system. Aspects of the invention relate to a brake caliper body, to a brake caliper, to a method, to a vehicle, to a computer program product and to a computer-readable medium.

### BACKGROUND

In vehicle disc braking systems, brake discs are fitted to two or more wheels of a vehicle. A respective brake caliper is fitted around each disc, the calipers having caliper pistons that can be actuated to press one or more brake pads onto the disc to slow its rotation by friction. This in turn brakes the wheel to which the disc is attached. In conventional systems, the brake pistons are actuated hydraulically by a brake pedal that is operable by the driver.

As the brake pedal is directly linked to the caliper pistons, the force exerted by the driver on the brake pedal is proportional to the force exerted by the pistons on the brake discs. Moreover, the hydraulic communication provides a level of feedback to the driver through the pedal. The response and feedback of the brake pedal is known as ‘pedal feel’, and in conventional braking systems the pedal feel is a central design constraint. This means that the components of the brake system are designed to optimize the response of the brake calipers to operation of the brake pedal, so that the brake system responds in the manner that a driver would expect it to. More specifically, the expected pedal feel defines the volumetric stiffness of the braking system, namely the volume of fluid displaced per unit of normal force delivered by the caliper.

One particular overall consideration in enhancing pedal feel is that it is desirable for the body of the caliper to be stiff. This is because any flexing of the caliper during braking increases the displacement required of the piston in order for it to continue to apply pressure to the disc. This elevates the extent to which the brake pedal must be depressed by the driver, since the piston displacement is directly proportional to the volume of hydraulic fluid displaced by the brake pedal. This could be mitigated by reducing the diameter of the pistons, but this would in turn raise the hydraulic pressure required in the braking system, which arises through a force applied to the pedal by the driver optionally in combination with additional force provided by a servo or booster.

The stiffness of a caliper body is typically quantified in terms of the ratio of the volume of hydraulic fluid consumed by the caliper and the pressure of that fluid. Therefore, by stiffening the caliper body the required piston displacement can be controlled and minimized, enabling the force applied to the disc in response to actuation of the pedal to be optimized.

In conventional calipers, each piston has a circumferential piston seal that is generally square in cross section. As the piston is displaced under hydraulic action its piston seal distorts due to its shape and the profile of a groove in which the seal resides. The distortion of the seal provides the mechanism by which the piston returns to its initial position once the hydraulic pressure is released. The capacity of the seal and groove is usually low relative to the displacement of the caliper body, meaning that on some occasions the piston does not fully retract. Thus, with successive braking operations the clearance between the brake pads and the disc when the brake pedal is released reduces; the brake pads may even come to be held resting on the disc continuously. The gradual progression of the piston compensates for wear of the friction layer of the brake pad, but continuous frictional contact between the brake pads and the discs has an impact on fuel efficiency.

The principal ways to stiffen a caliper body include using stiffer materials and adding bulk, each of which tend to increase the overall mass of the caliper. Although there is a general trend towards reducing vehicle weight and reducing off-brake drag in order to improve fuel efficiency, this mass increase is a compromise that has thus far been accepted as a necessary compromise.

In line with another trend in the automotive sector, namely the gradual electrification of vehicles, ‘brake-by-wire’ systems have now been proposed. In such systems movement of the brake pedal creates a control signal that is used to actuate the brake pistons electronically. The pistons may still be operated hydraulically, in which case the hydraulic fluid is pumped into the piston by an electrically controlled modulator rather than directly by the action of the brake pedal. There is therefore no hydraulic reaction force applied to the brake pedal, and so the pedal is artificially weighted so as to simulate the expected pedal feel. Alternatively, purely electronic braking means may be used. In either case, the brake pedal is de-coupled from the brake pistons, and so the brake calipers do not need to be designed to provide a required pedal feel. This dramatically increases design freedom for future calipers.

It is against this background that the present invention has been devised.

### SUMMARY OF THE INVENTION

Aspects and embodiments of the invention provide a brake caliper body, a brake caliper, a method, a vehicle, a computer program product and a non-transitory computer-readable medium as claimed in the appended claims.

According to an aspect of the invention there is provided a brake caliper body comprising an opening arranged to receive a portion of a brake disc, the position of the brake disc within the opening, in use, defining a brake disc envelope. The brake caliper body further comprises at least one pair of coaxial piston bores disposed one to each side of the opening, each piston bore having a closed end defining an end face. The brake caliper body also comprises at least one mounting hole. A center of each piston bore end face coincides with an ellipse defined around the brake disc envelope. The ellipse has foci lying within the brake disc envelope and is sized to coincide with lengthwise extremities of the disc envelope. The ellipse intersects or is tangential to the or each mounting hole.

It has been found that positioning features of the caliper body according to the ellipse enables the mass of the body to be minimized whilst maintaining sufficient strength to meet deflection targets.

The caliper body may be asymmetric in form, which, unlike a symmetric body, allows the mass of the body to be minimized in an unrestricted manner.

The caliper body may comprise a structural bridge spanning the opening that increases the stiffness of the body. The bridge may be integral with the caliper body to reduce the number of components, or the bridge may be removable from the caliper body to aid servicing.

The caliper body may be of monobloc construction, thereby dispensing with joints and fixings between separate body elements, and so providing a robust structure with minimized mass.

The caliper body optionally comprises plain abutments or pin abutments for limiting rotational movement of brake pads housed in the caliper body, in use.

In another aspect, there is provided a brake caliper for a brake-by-wire system. The brake caliper comprises a caliper body having an opening arranged to receive a brake disc, the caliper body defining one or more pairs of coaxial piston bores disposed one to each side of the opening. The caliper body may be a caliper body of the above aspect. The brake caliper further comprises a respective piston housed in each of the piston bores of the caliper body, and a pair of mutually opposed brake pads held within the opening of the caliper body. The brake caliper is arranged to maintain a clearance between the brake pads and the brake disc, in use.

By maintaining a running clearance between the brake pads and the brake disc, the brake caliper adopts a fundamentally different approach to those known in the art, in which piston seals are used to shift their respective pistons incrementally towards the brake disc to eliminate any clearances to account for wear of the brake pads. Maintaining a running clearance entails a caliper body of lower stiffness, allowing for a significant mass reduction compared with the conventional arrangements.

The brake caliper may comprise a respective piston seal in each piston bore, each piston seal being housed in a groove formed in an internal surface of the piston bore. In this case the groove has a profile that is shaped to ensure full retraction of the piston following a braking operation, thereby to maintain a clearance between the brake pads and the brake disc. The skilled person would be aware of how the shaping of the groove profile influences the extent of retraction of the piston following braking operations. For example, the groove may have a leading edge which is nearest the brake disc, in use, which the leading edge is formed on a radius that is large enough to ensure full retraction of the piston following a braking operation. Also, the groove may have a profile that is tapered axially such that the groove is deepest at its leading edge, or alternatively the groove may be tapered in the opposite direction so that it is shallowest at its leading edge. In such embodiments, the piston seal may have a cross-section that is shaped to interact with the profile of the groove so as to ensure full retraction of the piston following a braking operation.

The diameter of each of the piston bores may be minimized according to a hydraulic capacity of a modulator of the brake-by-wire system.

Another aspect of the invention provides a method of designing a brake caliper for a brake-by-wire system. The method comprises: defining operating parameters for the brake caliper; identifying a package space available to the brake caliper; defining a package envelope within the package space, the package envelope including an opening arranged to receive a brake disc, the position of the brake disc within the opening, in use, defining a brake disc envelope; defining an ellipse around the brake disc envelope, the ellipse having foci lying within the brake disc envelope and being sized to coincide with lengthwise extremities of the brake disc envelope; positioning within the package envelope one or more pairs of coaxial piston bores disposed one to each side of the opening, each piston bore having a closed end defining an end face, such that a center of each piston bore end face coincides with the ellipse, in which the diameters of the piston bores are minimized according to the operating parameters; positioning one or more mounting holes to intersect or touch the ellipse; reducing the mass of the package envelope and then checking that the package envelope does not exceed a deflection threshold on application of a force; and repeating the steps of reducing the mass of the package envelope and checking the deflection of the package envelope until the mass of the package envelope cannot be further reduced without exceeding the deflection threshold on application of the force.

This method provides a brake caliper whose mass is minimized according to its operating parameters as defined by the package space and package envelope. As the brake caliper forms part of the unsprung mass of a vehicle, reducing its mass has clear benefits in terms of ride quality and handling, as well as for general performance and fuel efficiency.

If the method is implemented on a computer, the package envelope may be a computer model representing a brake caliper body.

A further aspect of the invention provides a method of designing a brake caliper for a brake-by-wire system as described above, wherein an electronic processor electrically coupled to an electronic memory device having instructions stored therein, is configured to access the electronic memory device and to execute the instructions stored therein, such that the electronic processor is operable to: define said operating parameters for the brake caliper; identify said package space available to the brake caliper; define a package envelope within the package space, the package envelope including an opening arranged to receive a brake disc, the position of the brake disc within the opening defining a brake disc envelope; position within the package envelope one or more pairs of coaxial piston bores disposed one to each side of the opening, each piston bore having a closed end defining an end face, such that a center of each piston bore end face coincides with the ellipse, wherein the diameters of the piston bores are minimized according to the operating parameters; position one or more mounting holes to intersect or touch the ellipse; reduce the mass of the package envelope and then checking that the resulting package envelope does not exceed a deflection threshold on application of a force; and repeating the steps of reducing the mass of the package envelope and checking the deflection of the package envelope until the mass of the package envelope cannot be further reduced without exceeding the deflection threshold on application of the force.

The package envelope may comprise a computer model representing a brake caliper body, and said defining a package envelope may comprise the electronic processor being operable to define a computer model representing the brake caliper body.

A further aspect of the invention provides an apparatus for designing a brake caliper for a brake-by-wire system, the apparatus comprising an electronic processor electrically coupled to an electronic memory having instructions stored therein, the processor being configured to access the electronic memory device and execute the instructions stored therein such that it is operable to: define operating parameters for the brake caliper; identify a package space available to the brake caliper; define a package envelope within the package space, the package envelope including an opening arranged to receive a brake disc, the position of the brake disc within the opening defining a brake disc envelope; define an ellipse around the brake disc envelope, the ellipse having foci lying within the brake disc envelope and being sized to coincide with lengthwise extremities of the brake disc envelope; position within the package envelope one or more pairs of coaxial piston bores disposed one to each side of the opening, each piston bore having a closed end defining an end face, such that a center of each piston bore end face coincides with the ellipse, wherein the diameters of the piston bores are minimized according to the operating parameters; position one or more mounting holes to intersect or touch the ellipse; reduce the mass of the package envelope and then checking that the resulting package envelope does not exceed a deflection threshold on application of a force; and repeat the steps of reducing the mass of the package envelope and checking the deflection of the package envelope until the mass of the package envelope cannot be further reduced without exceeding the deflection threshold on application of the force.

The inventive concept also extends to a vehicle comprising the caliper body or the brake caliper of the above aspects. Other aspects of the invention provide a computer program product arranged to implement the above method, and a non-transitory computer-readable medium loaded with such a computer program product.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF DRAWINGS

One or more embodiments of the present invention will now be described, by way of example only, with reference to the accompanying drawings, in which like components are assigned like numerals, and in which:

FIG. 1 is a perspective view of a brake caliper according to an embodiment of the invention installed onto a brake disc;

FIG. 2 corresponds to FIG. 1 but shows the brake caliper in isolation;

FIG. 3 corresponds to FIG. 2 but shows a body of the brake caliper in isolation;

FIG. 4 is a perspective view of the brake caliper body shown in FIG. 3 as viewed from below;

FIG. 5 is a radial cross-sectional view of a portion of a piston bore of the brake caliper body shown in FIG. 3;

FIG. 6 is a cross-sectional view of the brake caliper of FIG. 1;

FIG. 7 is a detailed view of a mounting point of the brake caliper of FIG. 1;

FIG. 8 is a perspective view of a computer model of a brake caliper prior to analysis; and

FIG. 9 is a flow diagram showing a process for optimizing the mass of a brake caliper body.

### DETAILED DESCRIPTION

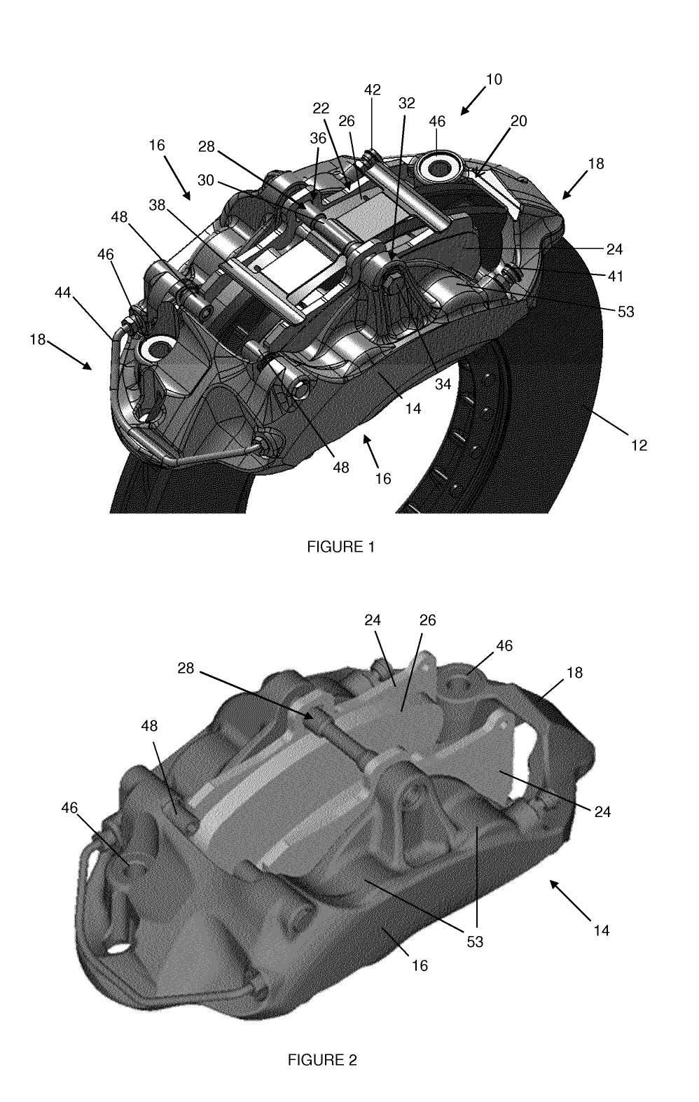

Embodiments of the invention provide opposed piston brake calipers that are optimized for use in brake-by-wire systems. An example of such a brake caliper 10 is shown in FIG. 1 in the context of its use, namely installed around a brake disc 12. The brake disc 12 is typically coupled to a wheel axle adjacent to a wheel of the vehicle, such that slowing rotation of the brake disc 12 in turn slows rotation of the wheel axle. The brake caliper is also shown in isolation in FIG. 2.

The caliper 10 comprises a monobloc, or one-piece, caliper body 14 of irregular form but which in general terms has two opposed parallel long sides 16 joined at their ends by two opposed parallel short sides 18. In use, the lengthwise sides 16 of the caliper body 14 are oriented parallel to the circular faces of the brake disc 12, and the widthwise sides 18 are oriented parallel to a rotational axis of the brake disc 12.

The caliper body 14 is hollow to define a central opening or cavity 20 within which a pair of mutually opposed brake pads 22 are housed. Each brake pad 22 is composed of a rigid backing plate 24 and a layer of friction material 26, and the brake pads 22 are oriented such that the layers of friction material 26 face each other. The brake pads 22 are spaced to define a gap between them within which the brake disc 12 is received.

A bridge 28 spans the cavity 20 in the widthwise direction to strengthen the caliper 10. The bridge 28 is in the form of a cylindrical shaft 30 which is received in respective coaxial holes 32 formed in each of the lengthwise sides 16 of the caliper body 14. The shaft 30 has an enlarged head 34 at one end which cooperates with a fixing (not shown) at the other end to secure the shaft 30 in place. The shaft 30 also passes through holes 36 formed in the tops of each of the backing plates 24 of the brake pads 22, enabling the bridge 28 to act as a guide for movement of the brake pads 22. Additional guides 38 are placed at either end of the top edges of the backing plates 24 to ensure that the brake pads 22 remain in parallel relation during operation. The skilled reader will appreciate that other methods may be used to retain the brake pads.

The caliper body 14 further includes a hydraulic circuit that is used to effect braking. The circuit comprises an inlet port 40, which is visible in FIG. 4 on one of the lengthwise sides 16. FIGS. 1 and 2 show a pair of outlet ports 41, 42 positioned at ends of the lengthwise side 16, and a hydraulic channel 44 providing communication between the inlet and outlet ports 40, 41, 42. The hydraulic channel 44 is primarily internal to the body 14, although there is an external portion of the channel 44 constituted by a tube extending over one of the short sides 18 of the body 14 to provide communication between the lengthwise sides 16 of the body 14.

In this embodiment, the caliper body 14 includes two mounting points in the form of mounting holes 46 that are arranged to receive bolts to enable the caliper body 14 to be secured to a vehicle, for example to an ‘upright’ within a wheel arch of the vehicle.

When the brake pads 22 are pressed against the brake disc 12, the frictional force arising urges the brake pads 22 to rotate in the same direction as the brake disc 12. For this reason, abutments 48 are included to act as mechanical stops to prevent the brake pads 22 from moving out of position. In the embodiment shown in FIGS. 1 and 2, the abutments 48 are of the ‘pin’ type, although the skilled reader will be aware that other abutment types are routinely used, such as ‘plain’ abutments. Either pin-type or plain-type abutments 48 can be used with calipers 10 according to embodiments of the invention.

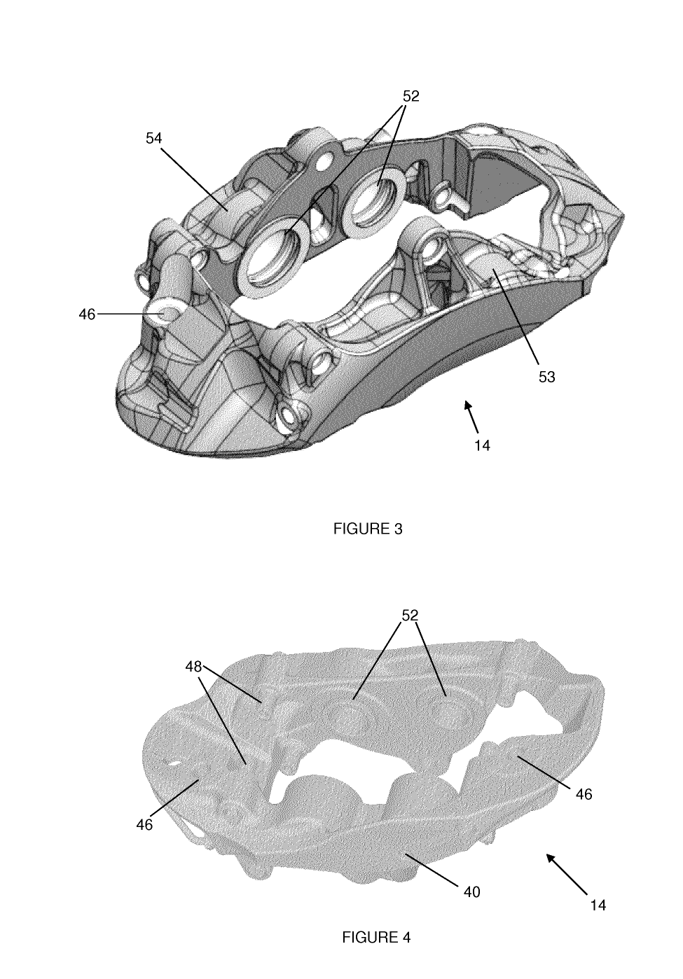

As shown more clearly in FIGS. 3, 4, 6 and 7, four pistons 50 are held within the caliper body 14, each within a respective piston bore 52. It should be appreciated that in other variants a different number of pistons may be used. Each lengthwise side 16 of the caliper body 14 has two piston bores 52, and each piston bore 52 is coaxial with a respective piston bore 52 on the opposite side 16 of the caliper body 14. It is noted that a bulge 53 is formed in the caliper body 14 around each of the piston bores 52. This is an efficient way to ensure sufficient wall thickness around the piston bores 52, where loadings are relatively high during braking operations, without adding significant bulk to the rest of the caliper body 14.

Each piston 50 is arranged to move, when actuated, towards its respective brake pad 22 to press the brake pad 22 onto the brake disc 12, thereby effecting braking. Each pair of pistons 50 is positioned with one piston 50 to either side of the center of the respective brake pad, so as to apply a balanced force. As the brake caliper 10 is optimized for use in a brake-by-wire system, the pistons 50 are actuated hydraulically by a modulator in response to a control signal generated when a driver of the vehicle presses a brake pedal. In other embodiments, the pistons 50 are actuated electronically.

The features of the brake caliper 10 that have been described thus far generally correspond to those found in conventional calipers. However, it will be apparent to the skilled reader that the caliper body 14 of the embodiment shown in FIGS. 1 to 4 is significantly less bulky than those of conventional calipers. The reasons for this are set out below, but it is noted at this point that the reduced bulk of the caliper body 14 entails a lower mass than is typical for a conventional caliper body. As already mentioned, there is a general aim in the automotive industry to reduce the weight of vehicles in the interests of fuel efficiency, and so the mass reduction of the caliper body 14 is a significant benefit. In real terms, it has been found that caliper bodies of embodiments of the invention can be two or three kilograms lighter than their conventional equivalents, which is a significant reduction. Furthermore, in light of the fact that the brake calipers 10 form part of a vehicle's unsprung mass, the mass reduction also serves to improve the performance, ride quality and handling of the vehicle.

As noted above, in a brake-by-wire system the brake pedal is decoupled from the brake pistons 50, and so pedal feel is no longer a constraint in caliper design. One particular implication of this that has been identified is that such calipers 10 do not necessarily need to be as stiff as those used in known low-drag calipers for conventional hydraulic braking systems, in which the design philosophy generally encourages maximized stiffness. This is because although any deflection of the caliper body 14 in operation increases the displacement required of the brake pistons 50, this increase can be accounted for by an electrical actuation system with no impact on the driver.

Therefore, the caliper 10 can be designed using strength rather than stiffness as a constraint. In other words, an allowable deflection defined for the caliper body 14 can be much larger than for conventional calipers in which deflection is minimized as far as possible. The allowable deflection remains within the elastic limit of the caliper body 14, and is factored into the design so that, in use, the caliper body 14 bends in a planned and controlled manner in response to the action of the pistons 50. Embodiments of the invention therefore adopt a completely opposed design philosophy to that of conventional practice in the art.

As the pistons 50 are configured for increased displacement without effect on the driver, a further advantage of this approach is that a running clearance can be defined between the brake pads 22 and the brake disc 12. This removes frictional contact between the two when the brakes are idle without compromising braking performance. In contrast, as described above conventional brakes typically adopt gradual progression of the piston towards the brake disc under the control of the piston seal, and allow constant frictional contact to ensure a high braking force can be applied, in particular in high performance brakes.

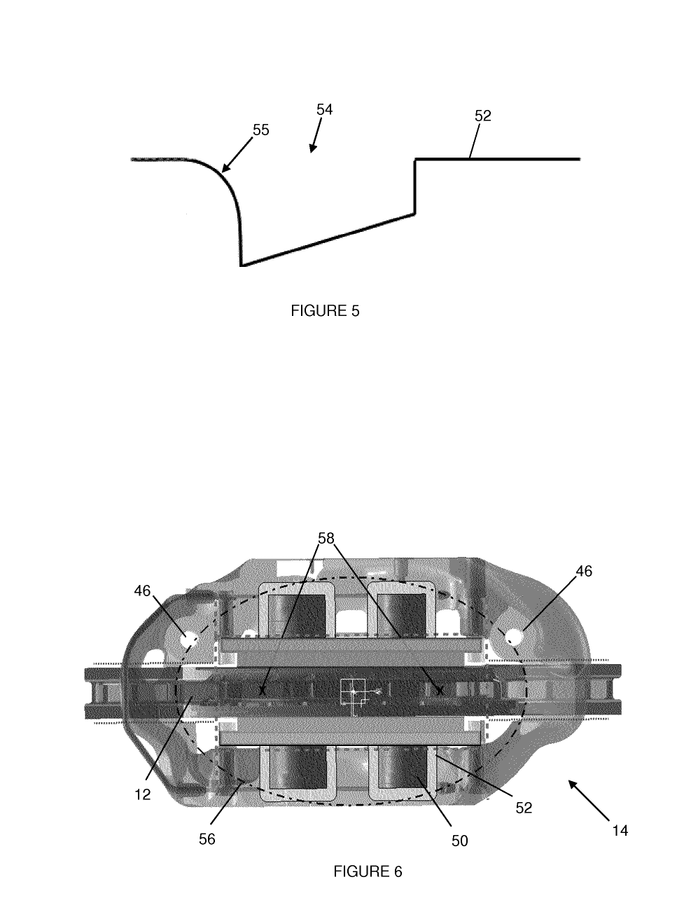

Therefore, in parallel with reducing the stiffness of the caliper body 14, a second design principle adopted in embodiments of the invention is to ensure maintenance of a running clearance between the brake pads 22 and the brake disc 12. This entails ensuring that once the hydraulic pressure is released, the piston 50 always retracts by a distance greater than the deflection of the caliper body 14. This is achieved through appropriate shaping of the piston seal and a groove 54 in which the seal sits, which is illustrated in FIG. 5. The groove 54 is formed annularly in the inner surface of the piston bore 52, and has a profile that is tapered axially such that in this embodiment the groove 54 is deepest at its leading edge 55, namely the edge nearest the brake disc. The leading edge 55 is formed on a radius to accommodate distortion of the piston seal during piston displacement. While this profile resembles that of a conventional caliper body, the relative dimensions are different: in particular, the radius of the leading edge 55 is considerably larger than that of its conventional counterparts to ensure that the piston seal, and in turn the piston 50, always retracts fully; even after the piston 50 is at maximum displacement. This sits in contrast with conventional calipers in which the piston seal is specifically configured to prevent full retraction of the piston in certain circumstances to provide a decreasing clearance between the brake pad and the brake disc.

It is noted that other groove profiles may be used in alternative embodiments, but in each case the radius of the leading edge 55 is sized so as to ensure full piston 50 retraction after every piston 50 operation.

Maintaining a running clearance ensures that energy is not wasted in friction when the brakes are not operating, and also prevents a build-up of heat in the brake discs 12 and brake pads 22. However, due to the larger clearance between the brake pads 22 and the brake disc 12 than would be present in conventional calipers, this approach requires a fast hydraulic prefill to ensure satisfactory response. This can be provided in a brake-by-wire system, and so the relationship between these design principles is clear.

It will be clear from the above description that there are several variables that affect the form of the caliper body 14. These variables include, but are not limited to: the number of pistons 50; the locations of the piston bores 52 within the caliper body 14; the piston bore 52 diameters; the type of abutments 48 used to hold the brake pads 22 in position; the size and positions of the mounting holes 46; the overall package space; the cooling system; the caliper body 14 material; and the type of bridge 28 used. Each of these variables influences the others to some extent and so must be accounted for in designing the caliper body 14.

Optimized configurations for these variables have been determined that allow for a maximized reduction in the mass of the caliper body 14. The caliper body 14 shown in FIGS. 1 to 4 and described above is an example of a caliper body 14 in which the configuration of the above variables has been optimized, allowing for subsequent minimization of the mass of the caliper body 14. That process is now described with reference to FIGS. 6 to 8.

The specific application in which a new brake caliper 10 is to be used serves as the starting point in the design of the caliper 10, as the application determines working parameters for the caliper 10, including the overall package space available, the size of the brake disc 12, and the braking performance required. These parameters directly influence the size and shape of the caliper body 14, the positions of the mounting holes 46, the number of pistons 50 used, the size of those pistons 50 and the size of the brake pads 22.

For example, it is noted that allowing more outboard lateral space, namely space between the brake disc 12 and the wheel, in which material can be placed improves the ability to meet target displacement characteristics while maintaining a low caliper body mass. Inboard package allowance for material is less significant to the specific purposes of optimizing the mass and stiffness of the caliper body 14, or the piston 50 displacement, and so can be treated according to conventional design practices. Also, to maintain flexibility in vehicle configuration, it is desirable to reduce the outer diameter of the packaging space of the caliper body 14, and it has been found that it is not detrimental to displacement or weight targets to do so.

Once the working parameters have been established, a next step is to determine the relative positions of the mounting holes 46 and the piston bores 52 with respect to the brake disc 12 and brake pads 22. As shown in FIG. 6, it has been found that the optimum solution is to locate the mounting holes 46 and the piston bores 52 according to an ellipse 56 drawn tightly around the brake disc 12, so that the major radius of the ellipse 56 touches or just clears the edge of the disc 12, and the minor radius of the ellipse 56 is determined such that the centers of closed rear ends of the bores 52, namely ends remote from the brake disc 12, coincide with the ellipse 56. The two focal points 58 of the ellipse 56 lie on the disc 12. The mounting holes 46 are also positioned as close as possible to the ellipse 56.

Typically the brake disc 12 and the piston bores 52 together define the ellipse 56, taking account of the number of piston bores 52 and the depths of each of those bores 52. The mounting holes 46 are then positioned according to the ellipse 56 in the manner described below, taking account also of other constraints such as brake pad abutments 48 and the desired brake disc clearance.

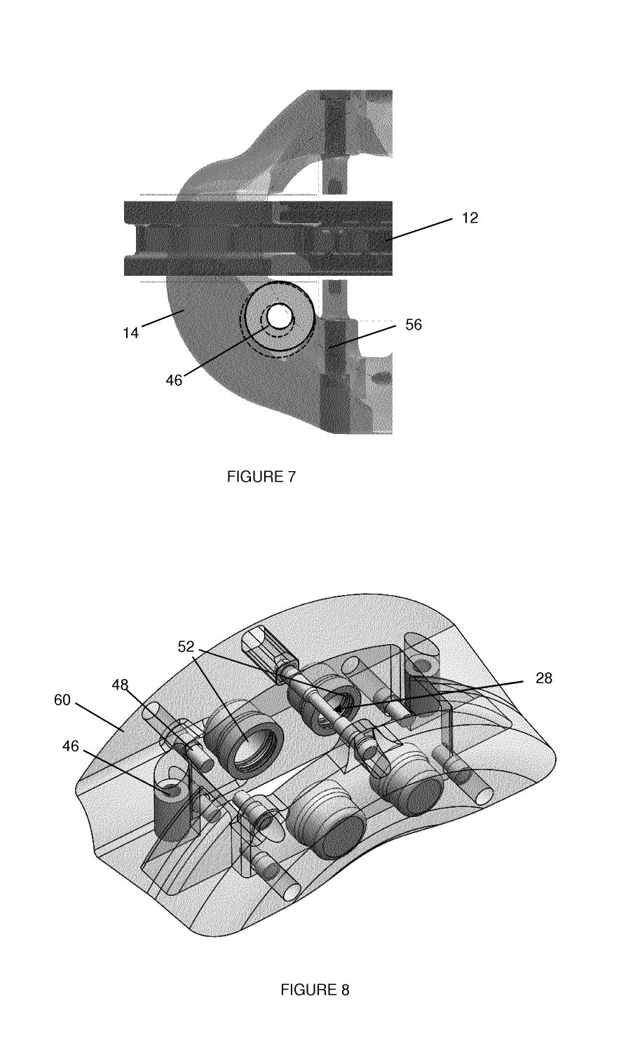

FIG. 7 shows how the position of a mounting hole 46 may be determined according to the size of the hole 46. As shown, in the smallest size, which in this example corresponds to an M12 fitting, the ellipse 56 slightly intersects the innermost region of the hole 46, namely the area of the hole 46 closest to the brake disc 12. The dashed lines indicate the positioning of the same mounting hole 46 if its size is increased, in this example to M16: the innermost point of the hole 46 remains in the same position, so that the ellipse 56 still crosses the hole 46 in this region. Noting that a minimum material thickness is defined around the mounting hole 46 to ensure structural integrity, it is apparent that increasing the size of the mounting hole 46 in turn increases its offset from the brake disc 12.

The position of the mounting hole 46, rather than its size, is the primary concern for an optimized configuration; the size of the hole 46 is selected to strike a balance between raising structural integrity and minimizing the offset of the mounting hole 46 from the brake disc 12. This is because it has been found that minimizing the offset between the mounting hole 46 and the brake disc 12 enables the mass of the caliper body 14 to be minimized. A smaller mounting hole 46 inherently has a smaller offset from the brake disc, but also entails a smaller, and therefore weaker, fixing. Therefore, the smallest fixing size that will provide sufficient strength is typically selected.

There are other factors that impact the positioning of the mounting hole 46, and so the hole 46 is positioned as close as possible to the ellipse 56 for an optimized solution. FIG. 6 shows in dashed lines areas of the caliper 10 into which the mounting hole 46 and its surrounding material cannot encroach. Those areas include a region immediately adjacent to the brake disc 12, to allow sufficient clearance from the disc 12, and a rectangular central region which designates an area occupied by the brake pads 22.

In view of these factors, together with the desire to position the mounting holes 46 on the ellipse 56, the position of each mounting hole 46 is dictated to within a small area.

The diameters of the piston bores 52 can also be optimized in pursuit of a low mass caliper body 14. In general, an optimized solution has a minimized bore diameter, as this means that the bulges 53 around the bores 52 are smaller in mass for a given thickness, and also less additional material is required to maintain the structural integrity of the body 14. Also, a small bore diameter entails a reduced volume of braking fluid.

However, there are some limitations that must be taken into account in determining the bore diameter. For example, there are legal requirements that apply in terms of fail-safe provisions: the brake must be able to apply a braking force sufficient to decelerate the vehicle by 2.84 m/s². Also, the hydraulic capability of the modulator of the brake-by-wire system must be considered; a smaller bore diameter entails a higher pumping pressure to generate a given braking force and piston 50 displacement, since the pressure acts over a smaller piston area. A further consideration is that the pistons 50 should be large enough to create a good pressure distribution on the brake pad 22 so that standard backing plates 24 can be used; a smaller bore diameter results in higher pressure concentration at the point of application on the backing plate 24.

The arrangement shown in FIG. 7 shows a specific optimization in which four pistons 50 are used. In line with conventional practice the piston bores 52 are not all of equal diameter: the bores 52 shown to the left are larger than those shown to the right. The pistons 50 are configured in this way so that braking force is distributed over the brake pad 22 in a manner that counteracts the tendency of the brake pad 22 to wear unevenly when they make contact with the brake disc 12. The positions of the piston bores 52 are determined in accordance with this requirement, and then the ellipse 56 is drawn around the brake disc 12 and through the centers of the piston bores 52 as described above. The mounting holes 46 can then be positioned according to the ellipse 56. If the size of the bore diameter were to be changed, or if further pistons 50 were to be added, the same constraints would be used to reconfigure the arrangement.

Finally, the type of abutments 48 and the type of bridge 28 to be used are selected. As noted above, either plain abutments or pin abutments can be used. A structural bridge 28 is often necessary for optimized mass reduction as it produces a more robust body 14 for a given mass; the additional reinforcement required to the sides of the caliper body 14 to produce a similar stiffness to that which can be achieved with a bridge 28 adds far more mass than the bridge 28. The bridge 28 can either be in the form of a removable member such as the shaft 30 described above, or alternatively an integral, fixed bridge 28 can be used. However, for very small caliper bodies, it has been found that omitting the bridge 28 produces an optimized solution.

As FIG. 8 shows, at this point the overall packaging space for the caliper body 14 has been defined, taking into account the sizes and positions of the piston bores 52 and the mounting holes 46, the type of abutment 48 used, and the type of bridge 28. These constraints are used to define a package space computer model representing an initial design for the caliper body 14, referred to as a ‘package envelope’ 60, that is in the familiar semi-cylindrical form taken by most caliper bodies, with a central opening or cavity 20 to accommodate the brake disc 12. At this stage the shape of the package envelope 60 simply fills the available space and so its mass is much higher than is necessary to satisfy stiffness requirements.

The package envelope 60 is passed to an analysis package that is able to remove mass from the package envelope 60 whilst monitoring its stiffness, to produce a structurally optimized solution. Each time the package removes material from the package envelope 60, the resulting body is analyzed using finite element analysis techniques to ensure that stiffness has not fallen below allowable design limits. Key constraints are defined on the package envelope 60 where specific limits apply. For example, the displacement of the piston bores 52 at their centers is tightly constrained according to the required deflection to ensure successful performance of the caliper body 14 during braking.

Eventually, the analysis package cannot remove any more pieces of the package envelope 60 without compromising target displacements, at which point the package envelope 60 is deemed to have a minimized mass. The resulting design can then be refined as necessary to ensure that it is practical to manufacture. This results in a final caliper body 14 such as that shown in FIGS. 1 to 4.

It is noted that the analysis package does not tamper with the features defined in the package envelope 60, such as the positions of the mounting holes 46 or the type of abutment. Therefore, the final caliper body 14 produced by the package is entirely dependent on the constraints created by these features. In this way, the above described process for defining the properties of these features enables use of the analysis package for the creation of an optimized design that is specific to the requirements of each application.

If the final caliper body 14 is produced by commercially available structural optimization software, the body 14 is typically asymmetrical in form, which is unusual in the art but entirely expected in view of the new design approach used to create the body 14; symmetrical designs result from efforts to stiffen the caliper body 14 as far as possible, whereas an asymmetric body is indicative of the body 14 being reinforced only where it is required, in a discriminatory manner.

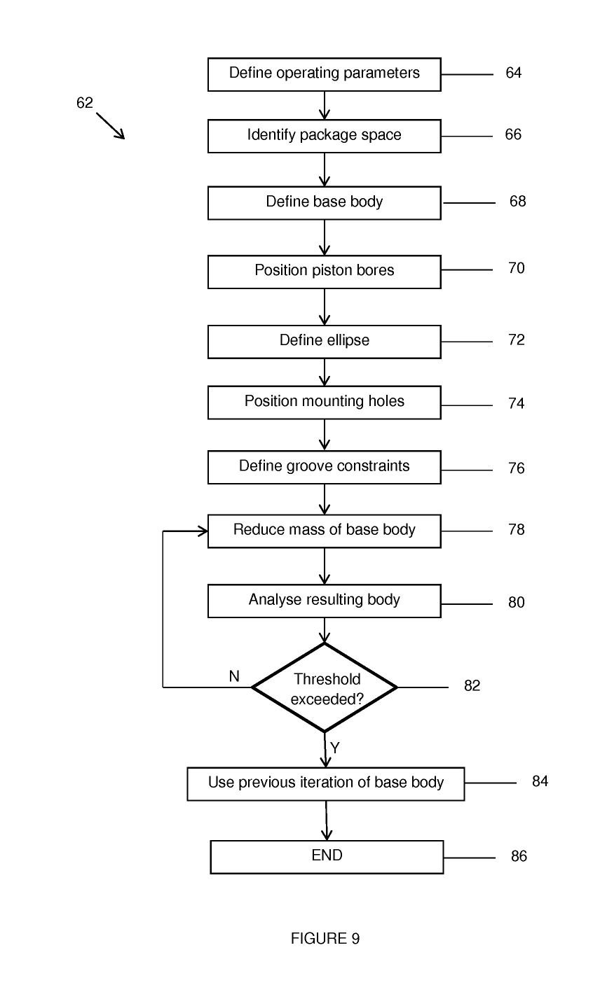

The above optimization is summarized in FIG. 9, which shows a process 62 for producing a final caliper body 14 with minimized mass. The process 62 begins with defining at step 64 the operating parameters for the brake caliper 10, including, for example, the braking force required, the number and size of the pistons 50 to be used, and the dimensions of the brake disc 12. Next, the package space is identified at step 66. Using this information, the package envelope 60 is defined at step 68. The piston bores 52 are positioned at step 70, and the ellipse 56 is then defined at step 72. It is noted that the ellipse 56 can be adjusted at this stage to accommodate the piston bores 52 if required. The mounting holes 46 are then positioned at step 74 in accordance with the ellipse 56. The groove 54 can then be constrained at step 76, which involves defining its axial profile to ensure full retraction of the pistons 50 following each braking operation. In alternative embodiments, steps 70 and 72 may be interchanged. In other words, the ellipse 56 may be defined prior to positioning of the piston bores 52.

The process 62 then moves into an analysis phase, in which the mass of the package envelope 60 is reduced as far as possible whilst retaining sufficient strength to avoid exceeding predetermined deflection thresholds on application of a force that the body will be subjected to in use. The analysis phase can be performed, for example, by commercially available structural optimization software.

Accordingly, the mass of the package envelope 60 is reduced by a small amount at step 78 by removing a portion of the available volume, and the resulting envelope 60 is analyzed at step 80 to check whether the envelope 60 exceeds predetermined deflections thresholds at specific locations on application of the force. Steps 78 and 80 iterate until one or more displacement thresholds are exceeded at step 82. At this stage, the previous iteration of the package envelope 60, namely the version of the package envelope 60 with the lowest mass that did not exceed the deflection thresholds, is taken forward at step 84 as the final caliper body 14. The process 62 then ends at step 86.

It will be appreciated by a person skilled in the art that the invention could be modified to take many alternative forms to that described herein, without departing from the scope of the appended claims.

1. A brake caliper body comprising:
an opening arranged to receive a portion of a brake disc, the position of the brake disc within the opening, in use, defining a brake disc envelope;
at least one pair of coaxial piston bores disposed one to each side of the opening, each piston bore having a closed end defining an end face; and
at least one mounting hole;
wherein a centre of each piston bore end face coincides with an ellipse defined around the brake disc envelope, the ellipse having foci lying within the brake disc envelope and the ellipse being sized to coincide with lengthwise extremities of the disc envelope;
and wherein the ellipse intersects or is tangential to the or each mounting hole.

2. A caliper body according to claim 1, wherein the caliper body is asymmetric in form.

3. A caliper body according to claim 1 or claim 2, comprising a structural bridge spanning the opening.

4. A caliper body according to claim 3, wherein the bridge is integral with the caliper body.

5. A caliper body according to claim 3, wherein the bridge is removable from the caliper body.

6. A caliper body according to any preceding claim, wherein the caliper body is of monobloc construction.

7. A caliper body according to any preceding claim, comprising plain abutments or pin abutments for limiting rotational movement of brake pads housed in the caliper body, in use.

8. A brake caliper for a brake-by-wire system, the brake caliper comprising:
a caliper body having an opening arranged to receive a brake disc, the caliper body defining one or more pairs of coaxial piston bores disposed one to each side of the opening;
a respective piston housed in each of the piston bores of the caliper body; and
a pair of mutually opposed brake pads held within the opening of the caliper body;
wherein the brake caliper is arranged to maintain a clearance between the brake pads and the brake disc, in use.

9. A brake caliper according to claim 8, comprising a respective piston seal in each piston bore, each piston seal being housed in a groove formed in an internal surface of the piston bore, wherein the groove has a profile that is shaped to ensure full retraction of the piston following a braking operation, thereby to maintain a clearance between the brake pads and the brake disc.

10. A brake caliper according to claim 9, wherein the piston seal has a cross-section that is shaped to interact with the profile of the groove so as to ensure full retraction of the piston following a braking operation.

11. A brake caliper according to claim 9 or claim 10, wherein the groove has a leading edge which is nearest the brake disc, in use, wherein the leading edge is formed on a radius that is large enough to ensure full retraction of the piston following a braking operation.

12. A brake caliper according to claim 11, wherein the groove has a profile that is tapered axially such that the groove is deepest at its leading edge.

13. A brake caliper according to claim 11, wherein the groove has a profile that is tapered axially such that the groove is shallowest at its leading edge.

14. A brake caliper according to any of claims 8 to 13, wherein the diameter of each of the piston bores is minimised according to a hydraulic capacity of a modulator of the brake-by-wire system.

15. A brake caliper according to any of claims 8 to 14, wherein the caliper body is a caliper body according to any of claims 1 to 7.

16. A method of designing a brake caliper for a brake-by-wire system, the method comprising:
defining operating parameters for the brake caliper;
identifying a package space available to the brake caliper;
defining a package envelope within the package space, the package envelope including an opening arranged to receive a brake disc, the position of the brake disc within the opening, in use, defining a brake disc envelope;
defining an ellipse around the brake disc envelope, the ellipse having foci lying within the brake disc envelope and being sized to coincide with lengthwise extremities of the brake disc envelope;
positioning within the package envelope one or more pairs of coaxial piston bores disposed one to each side of the opening, each piston bore having a closed end defining an end face, such that a centre of each piston bore end face coincides with the ellipse, wherein the diameters of the piston bores are minimised according to the operating parameters;
positioning one or more mounting holes to intersect or touch the ellipse;
reducing the mass of the package envelope and then checking that the resulting package envelope does not exceed a deflection threshold on application of a force; and
repeating the steps of reducing the mass of the package envelope and checking the deflection of the package envelope until the mass of the package envelope cannot be further reduced without exceeding the deflection threshold on application of the force.

17. The method of claim 16, wherein the method is implemented on a computer, and wherein the package envelope is a computer model representing a brake caliper body.

18. A vehicle comprising the caliper body of any of claims 1 to 7, or the brake caliper of any of claims 8 to 15.

19. A computer program product arranged to implement the method of claim 16 or claim 17.

20. A non-transitory computer-readable medium loaded with the computer program product of claim 19.

21. A caliper body, a brake caliper or a method substantially as herein described, and/or as illustrated in any one of the accompanying figures.
